(19) United States
(12) Patent Application Publication
(10) Pub. No.: US 2018/0297574 A1
(43) Pub. Date: Oct. 18, 2018

(54) METHOD FOR DETECTING A LEAK OF A HYDRAULIC BRAKE SYSTEM OF A VEHICLE

(71) Applicant: Continental Teves AG & Co. oHG, Frankfurt (DE)

(72) Inventors: Jochen ZIMMERMANN, Oberwallmenach (DE); Thorsten ULLRICH, Gernsheim (DE)

(73) Assignee: Continental Teves AG & Co. oHG, Frankfurt (DE)

(21) Appl. No.: 15/949,540

(22) Filed: Apr. 10, 2018

Related U.S. Application Data
(63) Continuation of application No. PCT/EP2016/071680, filed on Sep. 14, 2016.

(30) Foreign Application Priority Data
Oct. 14, 2015 (DE) 10 2015 219 905.3

(51) Int. Cl. B60T 17/22; B60T 13/66; B60T 13/16; B60T 13/68; G01L 19/14

(52) U.S. Cl. CPC B60T 17/221; B60T 13/662; B60T 13/167; B60T 13/686; B60T 2270/308; B60T 2270/88; B60T 2270/82; B60T 2270/14; G01L 19/148

(57) ABSTRACT

A method for detecting a leak of a hydraulic brake system of a vehicle having at least two wheel brakes. A slip control of the wheel brake assigned to the respective vehicle wheel is carried out by a respective pressure modulation unit. The pressure medium volume delivered by a brake pressure source is detected. A pressure sensor output identifies a model value for the pressure value detected by the pressure sensor. A differential value is determined which indicates the difference between the pressure medium volume delivered and the model value, and the differential value is compared with a threshold, and a leak is reported if the differential value exceeds the threshold.

### FIELD OF THE INVENTION

The invention relates to a method for detecting a leak of a hydraulic brake system of a vehicle.

### BACKGROUND

Two-axle vehicles are fitted with hydraulic systems that have two brake circuits, thus ensuring that, if one of the two brake circuits fails, the vehicle can still be braked by means of the other brake circuit. In general, the wheel brakes are associated with the brake circuits in a diagonally split arrangement, in which a brake circuit acts on one front wheel and the respective diagonally opposite rear wheel. The two brake circuits are connected to a master brake cylinder, to which a brake pedal actuated by a driver to build up a corresponding brake pressure in the two brake circuits is coupled.

To implement a “brake-by-wire” brake system with a fallback level, a displacement simulator, an electrically controllable pressure source, two block valves (also referred to as connecting valves) and two circuit block valves are required in addition to the brake-pedal-actuated master brake cylinder. For the “brake-by-wire” operating mode, the wheel brakes are separated from the master brake cylinder by means of the block valves, while the wheel brakes are connected via the circuit block valves to a controllable pressure source common to both brake circuits or to a respective controllable pressure source provided for each of the brake circuits.

Such brake systems comprise a large number of hydraulic lines, which are interconnected by the valves in different ways, and therefore the occurrence of leaks cannot be excluded. Particularly in the case of “brake-by-wire” brake systems, there is the disadvantage that haptic feedback signals from the brake circuits are not transmitted to the brake pedal when said brake circuits are separated from the master brake cylinder. However, such haptic feedback is desired as a comfort feature. Therefore, a displacement simulator is connected in parallel with the master brake cylinder, said simulator imparting to the driver a pedal characteristic of a conventional brake system when the brake pedal is actuated if the wheel brakes are supplied with pressure medium from the pressure medium reservoir by the electrically controllable pressure source to generate a brake pressure. However, the disadvantage here is that it is not possible to achieve haptic feedback signals which indicate to the driver the safety and integrity of the brake system. This relates, for example, to increased volume inclusions, such as air or leaks, which are indicated in conventional brake systems by the absence of force feedback at the brake pedal. Mismatches in the volumes of a “brake-by-wire” brake system must therefore be detected electronically.

Since the brake circuits are interconnected to form a single hydraulic circuit in the “by-wire” mode in many “brake-by-wire” brake systems, it is necessary not only to detect leaks but also to locate them; it is therefore necessary to determine the brake circuit which has the leak in order to selectively isolate said brake circuit and keep the remaining brake circuit fit for braking.

DE 699 37 155 T2 discloses a method for detecting a leak within a hydraulic anti-lock and/or traction control system. In this method, a hydraulic pressure is built up by means of a high-pressure pump driven by an electric motor and is estimated by estimating means, e.g. software means within existing control components, taking into account the running time of the high-pressure pump. The reduction in speed of a vehicle wheel brought about by the hydraulic pressure built up is measured by already existing wheel speed sensors. The absence or presence of a leak within the hydraulic brake system is determined by means of a predefined relationship between the estimated pressure and the resulting speed of the braked vehicle wheel. It is furthermore stated in DE 699 37 155 T2 that it is particularly advantageous to build up the hydraulic pressure to be estimated by means of the high-pressure pump driven by the electric motor during a slip control operation. The leak is determined by subtracting the detected speeds of the vehicle wheels braked by means of the hydraulic pressure built up from one another and comparing the difference with a threshold. In this case, the presence of a leak is determined when this threshold is exceeded.

It can be regarded as a disadvantage of this method known from DE 699 37 155 T2 that the detection of a leak is based on the sensor signals of wheel speed sensors, which leads to a high degree of uncertainty due to the inaccuracy of these sensor signals in determining a leak.

### SUMMARY

Proceeding from this prior art, it is the object of the present invention to specify an improved method for detecting a leak in a hydraulic brake system of a vehicle.

This object is achieved by a method having the features of patent claim 1. According to the invention, a method of this kind for detecting a leak of a hydraulic brake system of a vehicle is characterized in that a) at at least two wheel brakes, a slip control of the wheel brake assigned to the respective vehicle wheel is carried out by means of a respective pressure modulation unit, b) in order to carry out the slip control, the wheel brakes are hydraulically connected to an electrically controllable pressure source, and a pressure medium volume is delivered from a pressure medium reservoir in order to generate a corresponding brake pressure, c) the pressure medium volume delivered by the pressure source is detected, d) a pressure sensor is provided in order to detect the brake pressure generated on the basis of the pressure medium volume delivered, e) a model value for the pressure value detected by the pressure sensor is specified in accordance with the detected pressure medium volume, wherein the model value indicates a theoretically correct value of the pressure medium volume required to build up the detected pressure value, f) a differential value is determined which indicates the difference between the pressure medium volume delivered and the model value, and g) the differential value is compared with a threshold, and a leak is reported if the differential value exceeds the threshold.

In this method according to the invention, a leak in a brake circuit during the performance of a slip control operation, i.e. during an ABS braking operation, is detected, on the one hand, by measuring the brake pressure generated by the pressure source by means of a pressure sensor and, on the other hand, by determining the pressure medium volume delivered for this purpose by the pressure source and comparing it with a model value. If the difference between the pressure medium volume determined and the model value exceeds a specified threshold, the presence of a leak in the brake system is assumed. The ABS braking operation is not disrupted by the method according to the invention for detecting a leak. The duration of the method according to the invention can be restricted in such a way that, on the one hand, it is not less than a certain minimum duration so as to allow an ABS control operation and, on the other hand, it does not exceed a maximum duration so as to optimize the braking power.

It is furthermore advantageous that, to carry out the method according to the invention for detecting a leak during an ongoing ABS control operation, no additional sensors, e.g. wheel pressure sensors or wheel speed sensors, are required. The sensors used to carry out the method according to the invention are generally already present in conventional hydraulic brake systems and in “brake-by-wire” brake systems. The method according to the invention can therefore be implemented exclusively by means of software within a brake control unit.

The pressure medium volume delivered by the electrically controllable pressure source is determined from control data of the pressure source, which depend on the way in which this pressure source is implemented. If a pump operating on the positive displacement principle and having an electric drive motor as a pressure source is used, a constant displacement volume is delivered from the pressure medium reservoir during each revolution of the drive shaft of the drive motor. The pressure medium volume delivered by a pressure source of this kind can thus be determined from the number of revolutions, which is determined by means of a speed sensor, and from the constant displacement volume. If, on the other hand, the electrically controllable pressure source is designed as a hydraulic cylinder-piston arrangement or as a single-circuit electrohydraulic actuator (linear actuator), the piston of which can be actuated by an electric drive motor via a rotation/translation mechanism, the position of the piston can be determined by means of a rotor position sensor, which detects the rotor position of the drive motor. The pressure medium volume delivered is determined from the position of the piston of the electrohydraulic actuator, which is determined by means of the rotor position sensor. The position of the piston of the electrohydraulic actuator can also be determined by means of a displacement sensor.

To enable the method according to the invention to be used in a conventional hydraulic brake system, it is envisaged, according to an advantageous embodiment of the invention, that two wheel brakes respectively form a first and a second brake circuit, the wheel brakes of the first and second brake circuits are each connected to an electrically controllable pressure source, wherein the controllable pressure sources of the two brake circuits are each designed as hydraulic pumps, which are driven by a common electric drive motor, to detect the pressure medium volume delivered by a hydraulic pump of a brake circuit, the number of revolutions performed for this purpose by the electric drive motor is determined, a respective pressure sensor is provided in order to detect the brake pressure generated in the brake circuits on the basis of the pressure medium volume delivered, to locate a leak, method steps e) to g) are carried out by means of at least one of the two brake circuits, while the pressure modulation units of the other brake circuit are controlled in such a way that the associated wheel brakes generate a specified brake pressure, and—if no leak is indicated, method steps e) to g) are carried out by means of the other brake circuit, while the pressure modulation units of the first brake circuit are controlled in such a way that the associated wheel brakes generate a specified brake pressure.

To enable the method according to the invention to be used in an electrohydraulic brake system, it is envisaged, according to an advantageous embodiment of the invention, that two wheel brakes respectively form a first and a second brake circuit, the two brake circuits are each connected to an electrically controllable pressure source via a circuit block valve, wherein the pressure source is designed as an electrohydraulic actuator, which is driven by an electric drive motor, to detect the pressure medium volume delivered by the electrohydraulic actuator, the rotor position of the electric drive motor is detected by means of a rotor position sensor, to locate a leak, method steps e) to g) are carried out by means of at least one of the two brake circuits, while the pressure modulation units of the other brake circuit are controlled in such a way that the associated wheel brakes generate a specified brake pressure, and—if no leak is indicated, method steps e) to g) are carried out by means of the other brake circuit, while the pressure modulation units of the first brake circuit are controlled in such a way that the associated wheel brakes generate a specified brake pressure.

To locate a leak, the circuit block valves are preferably controlled in such a way as to adopt the through flow position. The method according to the invention is explained in greater detail and described below with reference to the attached figures.

### BRIEF DESCRIPTION OF THE FIGURES

In the drawing:

FIG. 1 shows a schematic illustration of a hydraulic brake system to illustrate an embodiment of the method according to the invention; and

FIG. 2 shows a schematic illustration of an electrohydraulic brake system to illustrate another embodiment of the method according to the invention.

### DETAILED DESCRIPTION

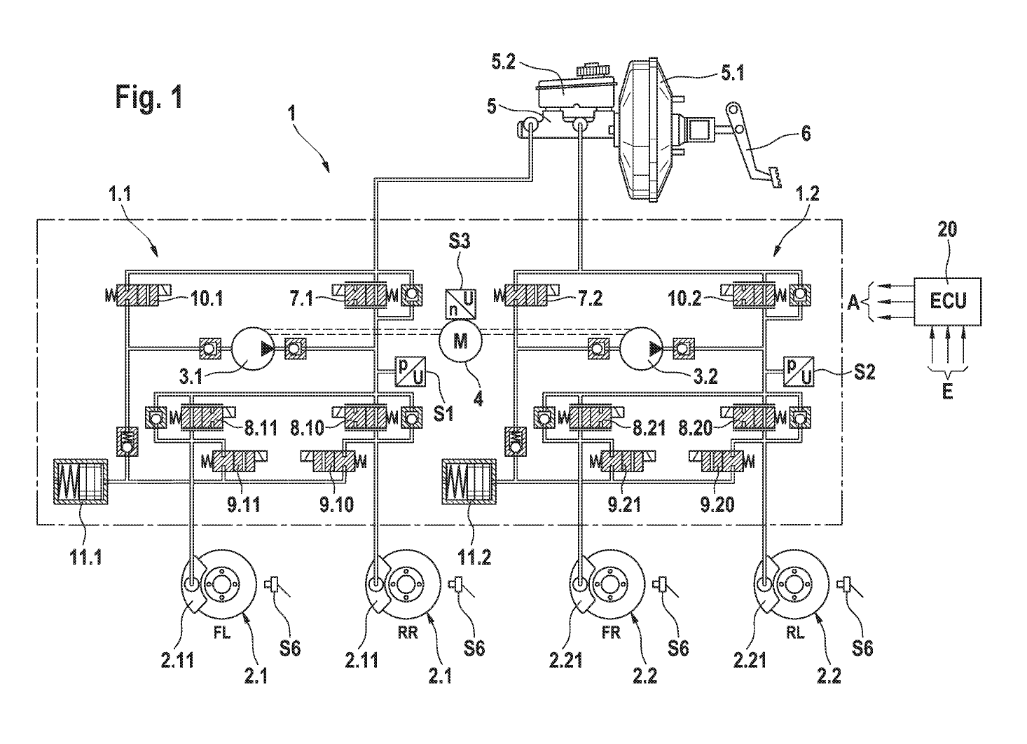

FIG. 1 shows an electronically controlled hydraulic brake system 1 on a vehicle, having a first brake circuit 1.1 and a second brake circuit 1.2 as well as a brake control unit 20, which generates control signals for the valves of the two brake circuits 1.1 and 1.2 as output signals A on the basis of sensor signals E as input signals.

The first brake circuit 1.1 for a front left-hand wheel 2.1 (FL) and a rear right-hand wheel 2.1 (RR) is connected via a block valve 7.1 to a master brake cylinder 5 embodied as a tandem brake cylinder (THZ). The second brake circuit 1.2 for a front right-hand wheel 2.2 (FR) and a rear left-hand wheel 2.2 (RL) is likewise connected to the master brake cylinder 5 via a block valve 7.2. Wheel brakes 2.11 and 2.21 of the wheels 2.1 and 2.2, respectively, are connected by respective hydraulic lines to the first brake circuit 1.1 and the second brake circuit 1.2.

The brake system 1 has a brake booster 5.1, which is connected to the master brake cylinder 5, and a storage reservoir 5.2 for the brake fluid or hydraulic fluid as the pressure medium. On the output side, the master brake cylinder 5 generates a brake pressure P as a feed pressure in accordance with a brake pedal 6, which is connected to the brake booster 5.1 and is actuated by a driver. This feed pressure is fed to the inlet side of the open inlet valves 8.10 and 8.11 of the first brake circuit 1.1 and the open inlet valves 8.20 and 8.21 of the second brake circuit 1.2 via the open block valves 7.1 and 7.2 to enable a corresponding hydraulic brake pressure to build up at the wheel brakes 2.11 and 2.21 of the wheels 2.1 and 2.2. The inlet valves 8.10 and 8.11 as well as 8.20 and 8.21 are normally open.

Normally closed outlet valves 9.10 and 9.11 of the first brake circuit 1.1 connect the wheel brakes 2.11 to a low-pressure reservoir 11.1, which, for its part, is connected to a hydraulic pump 3.1 as a pressure source on the intake side and can be connected via a changeover valve 10.1 to the master brake cylinder 5. In corresponding fashion, normally closed outlet valves 9.20 and 9.21 of the second brake circuit 1.2 connect the wheel brakes 2.11 to a low-pressure reservoir 11.2, which, for its part, is connected to a hydraulic pump 3.2 as a pressure source on the intake side and can likewise be connected via a changeover valve 10.2 to the master brake cylinder 5.

When the block valve 7.1 or 7.2 is closed, the hydraulic pumps 3.1 and 3.2 serve to build up pressure at the wheel brakes 2.11 and 2.21 by drawing in pressure medium from the storage reservoir 5.2 during an ABS or ESC control operation with changeover valve 10.1 or 10.2 open. During such an ABS or ESC control operation, the inlet and outlet valves 8.10 and 9.10, 8.11 and 9.11, 8.20 and 9.20, and 8.21 and 9.21 assigned to wheel brakes 2.11 and 2.21 are activated alternately as pressure modulation units by the control unit 20 in the manner known to a person skilled in the art. To enable the pressure medium to be withdrawn from the wheel brakes 2.11 and 2.21 during an ABS or ESC control operation, the changeover valve 10.1 and 10.2, respectively, and the inlet valves 8.10 and 8.11, and 8.20 and 8.21, respectively, are closed, while the outlet valves 9.10 and 9.11, and 9.20 and 9.21 respectively, are open.

In the case of an ABS or ESC intervention, the pressure medium displaced into the low-pressure reservoirs 11.1 and 11.2 during a pressure reduction is pumped out again by means of the hydraulic pumps 3.1 and 3.2.

To detect the rotational behavior of the wheels 2.1 and 2.2, there are respective speed sensors S6, which feed their sensor signals to the control unit 20 for evaluation to enable a corresponding slip control operation to be carried out at the wheels 2.1 and 2.2.

The hydraulic pumps 3.1 and 3.2 are driven by an electric motor 4, which is electrically controllable by the control unit 20. Here, the electric motor 4 is activated in such a way that the hydraulic pumps 3.1 and 3.2 can build up a brake pressure on the high-pressure side by drawing in brake fluid on the intake side. This brake pressure built up by the hydraulic pumps 3.1 and 3.2 is in each case measured by a pressure sensor S1, which is arranged in the first brake circuit 1.1, and another pressure sensor S2, which is arranged in the second brake circuit 1.2.

To determine the volume of pressure medium which was delivered by the hydraulic pump 3.1 or 3.2 to build up the brake pressure measured by the pressure sensor S1 or S2, a speed sensor S3 of the electric motor 4 is provided, which measures the number of revolutions corresponding to the pressure medium volume delivered.

In the case of a hydraulic pump 3.1 or 3.2 operating on the positive displacement principle, a constant displacement volume is delivered from the pressure medium reservoir 5.2 during each revolution of the drive shaft of the drive motor 4. The pressure medium volume delivered by the hydraulic pump 3.1 or 3.2 can thus be determined from the number of revolutions measured by the speed sensor S3 and from the constant displacement volume.

It is also possible to activate the electric motor 4 with pulse width modulation (PWM) by means of the control unit 20. By way of the number of pulses required for the pressure buildup, it is likewise possible to determine the volume of pressure medium delivered since the pressure medium volume delivered per pulse is known.

Detection of a leak in the first brake circuit 1.1 or in the second brake circuit 1.2 is accomplished by using pressure sensor S1 or S2 to measure the brake pressure generated in the brake circuit 1.1 or 1.2 during an ABS or ESC control operation and determining the pressure medium volume delivered for this brake pressure by means of the speed sensor S3. Depending on the brake pressure determined, a model value for the pressure medium volume delivered at this determined brake pressure is determined by means of the control unit 20, wherein the model value indicates a theoretically correct value of the pressure medium volume required to build up the pressure value detected. The pressure medium volume determined by means of the speed sensor S3 is compared with this model value. If the difference between the pressure medium volume determined and the model value exceeds a specified threshold, the presence of a leak in the brake system is assumed.

The model value for the pressure medium volume is determined in accordance with the brake pressure measured in the first or second brake circuit 1.1 or 1.2 by means of a pressure/volume characteristic stored in the control unit 20. It is also possible for a pressure/volume characteristic of this kind to be stored in the control unit 20 for each of the wheels 2.1 of the first brake circuit 1.1 and the wheels 2.2 of the second brake circuit 1.2. Such a pressure/volume characteristic indicates the pressure medium requirement or volume consumption for the wheels 2.1 of the first brake circuit 1.1 and for the wheels 2.1 of the second brake circuit 1.2 as a function of the brake pressure.

To determine such leakage in the brake system 1 shown in FIG. 1, the brake circuits 1.1 and 1.2 are tested individually by the control unit 20. For this purpose, the control unit 20 closes the inlet valves 8.10 and 8.11 of the first brake circuit 1.1, for example, or adjusts them to a brake pressure such that the stability of the vehicle in terms of driving dynamics is assured. The brake pressure of the first brake circuit 1.1 is set in such a way, for example, that the occurrence of slip at the wheels 2.1 is only just excluded.

The second brake circuit 1.2 is checked for leakage by determining the associated brake pressure using the pressure sensor S2 and determining the pressure medium volume delivered during an ABS or ESC control operation by means of an algorithm stored in the control unit 20 on the basis of the sensor value of the speed sensor S3. The model value for the pressure medium volume, which is determined from the measured brake pressure, is compared with the pressure medium volume determined and, if appropriate, a leak is identified by the control unit 20 by setting a leakage flag if the difference exceeds the specified threshold.

If no leak is identified by means of the control unit 20, the first brake circuit 1.1 is enabled again, i.e. the inlet valves 8.10 and 8.11 are opened for an ABS or ESC control operation and the second brake circuit 1.2 is isolated by closing the inlet valves 8.20 and 8.21 or controlling them in such a way that the wheel brakes 2.21 are supplied with a brake pressure which ensures the stability of the vehicle in terms of driving dynamics. Here, the brake pressure can be set in such a way that the occurrence of slip at the wheels 2.1 is only just excluded. The method described above is then carried out again by the control unit 20 by comparison of the model value with the pressure medium volume determined. If a leakage flag is set by the control unit 20, there is a leak in this second brake circuit 1.2. Because of the leak detected in this second brake circuit 1.2, this brake circuit is permanently isolated by the control unit 20, i.e. the inlet valves 8.20 and 8.21 are closed until the leak has been eliminated. The first brake circuit 1.1 thus continues to be functional, and therefore the vehicle can be braked or an ABS control operation carried out by means of the wheel brakes 2.11 at the front left-hand wheel 2.1 and the rear right-hand wheel 2.1.

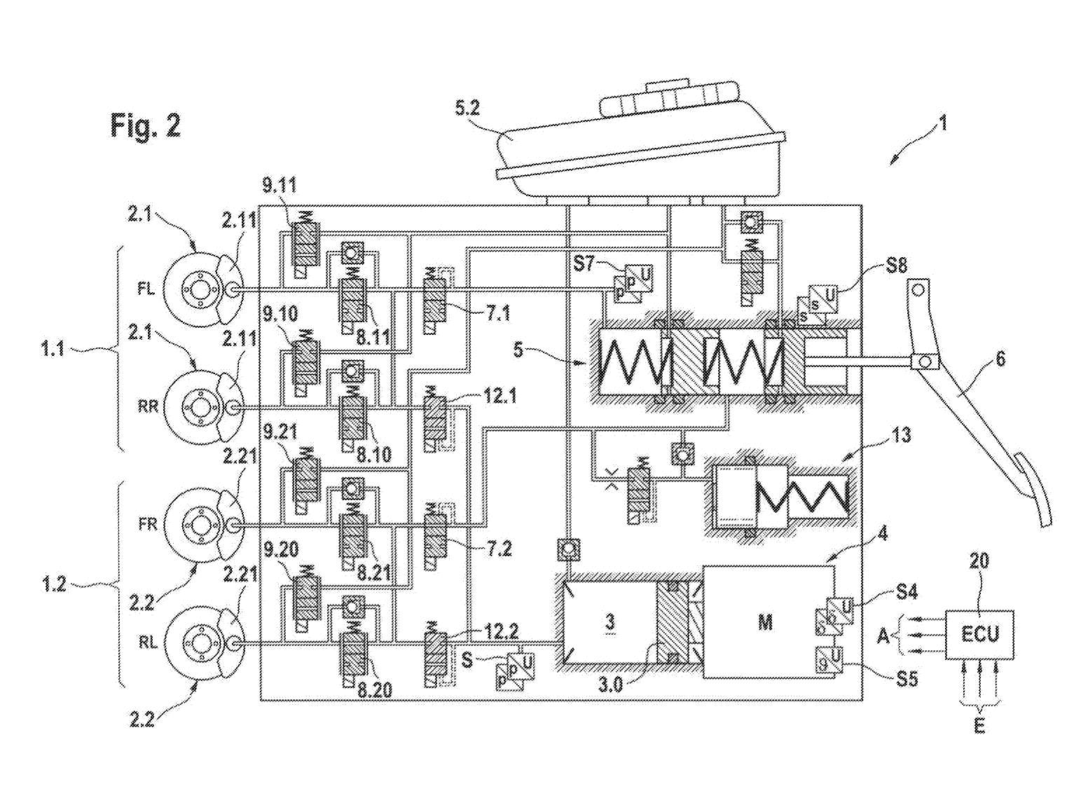

The method according to the invention for detecting a leak and for locating said leak in the brake system is explained by means of FIG. 2 with reference to a “brake-by-wire” brake system 1.

This brake system 1 shown in FIG. 2 comprises a master brake cylinder 5 that can be actuated by means of a brake pedal 6, a displacement simulator 13 interacting with the master brake cylinder 5, a pressure medium reservoir 5.2 connected to the master brake cylinder 5, an electrically controllable pressure source 3, which is designed as an electrohydraulic actuator with an electric motor 4 as a drive motor, controllable pressure modulation devices with wheel brakes 2.11 for a front left-hand wheel 2.1 (FL) and a rear right-hand wheel 2.1 (RL) and with wheel brakes 2.21 for a front right-hand wheel 2.2 (FR) and a rear left-hand wheel 2.2 (RL), and a control unit 20.

An inlet valve and an outlet valve 8.10 and 9.10, 8.11 and 9.11 in each case form a pressure modulation device for the two wheel brakes 2.11 of a first brake circuit 1.1, and an inlet valve and an outlet valve 8.20 and 9.20, 8.21 and 9.21 in each case form a pressure modulation device for the two wheel brakes 2.21 of a second brake circuit 1.2.

In a “brake-by-wire” operating mode, the inlet valves 8.10 and 8.11, 8.20 and 8.21 are connected via a circuit block valve 12.1 and 12.2, respectively, to the electrically controllable pressure source 3 for generating a system pressure. To measure the system pressure generated by the pressure source 3, a pressure sensor S is arranged on the high-pressure side thereof. Furthermore, each outlet valve 9.10, 9.11, 9.20 and 9.21 is connected to the pressure medium reservoir 5.2.

The master brake cylinder 5 is embodied as a dual-circuit tandem master cylinder and is connected to the pressure medium reservoir 5.2. To form a fallback plane of the “brake-by-wire” brake system 1, the master brake cylinder 5 can be connected to the wheel brakes 2.11 of the first brake circuit 1.1 via a block valve 7.1 and to the wheel brakes 2.21 of the second brake circuit 1.2 via another block valve 7.2. The brake pressure generated in this case is measured by means of a pressure sensor S7. By means of these block valves 7.1 and 7.2, the hydraulic connection between the master brake cylinder 5 and the first and second brake circuit 1.1 and 1.2 is divided in the “brake-by-wire” operating mode.

By means of a displacement sensor S8, the extent of a pedal actuation brought about by the driver, i.e. the movement of a piston rod of the wheel brake cylinder 5, said piston rod being connected to the brake pedal 6, is determined and represents a braking demand of the driver. The displacement simulator 13 is coupled hydraulically to the master brake cylinder 5 and simulates a haptic feedback corresponding to the brake pressure generated, i.e. a corresponding pedal feel, to the brake pedal 6.

The electrically controllable pressure source 3 is designed, for example, as a single-circuit electrohydraulic actuator, the piston 3.0 of which can be actuated by an electric motor 4 via a rotation/translation mechanism. The piston 3.0 delimits a pressure space, which is connected to the pressure medium reservoir 5.2 in order to draw in pressure medium. The position of the piston 3.0 is determined from the rotor position of the electric motor 4, which is determined by means of a rotor position sensor S4, thus allowing the pressure medium volume delivered to be determined from said piston position.

A leak during the “brake-by-wire” operating mode is detected by using the pressure sensor S to measure the brake pressure generated during a braking operation, e.g. an ABS control operation, with the circuit block valves 12.1 and 12.2 open, and determining the pressure medium volume delivered for this brake pressure by means of the speed sensor S3. Depending on the brake pressure determined, a model value for the pressure medium volume delivered at this determined brake pressure is determined by means of the control unit 20, wherein the model value indicates a theoretically correct value of the pressure medium volume required to build up the pressure value detected. The pressure medium volume determined by means of the rotor position sensor S4 is compared with this model value. If the difference between the pressure medium volume determined and the model value thereof exceeds a specified threshold, the presence of a leak in the brake system 1 is assumed.

The model value for the pressure medium volume is determined by means of a pressure/volume characteristic stored in the control unit 20 in accordance with the brake pressure measured by means of the pressure sensor S. The identified leak in the brake system is located by first of all isolating one of the two brake circuits 1.1 or 1.2 and continuing to subject the other brake circuit 1.2 or 1.1 to ABS control.

Isolation of the first brake circuit 1.1, for example, is accomplished by controlling this first brake circuit 1.1 in such a way in synchronism with the ABS control operation in the second brake circuit 1.2 that the stability of the vehicle in terms of driving dynamics continues to be assured, e.g. by supplying the wheels 2.1 with a brake pressure which is just below that which would allow slip at these wheels 2.1.

This second brake circuit 1.2 is then checked for leakage by detecting the associated brake pressure using the pressure sensor S and determining the pressure medium volume delivered during the ABS or ESC control operation by means of an algorithm stored in the control unit 20 on the basis of the sensor value of the rotor position sensor S4. The measured brake pressure is used to determine a model value for the pressure medium volume, which likewise indicates a theoretically correct value of the pressure medium volume required to build up the pressure value detected, and this model value is compared with the pressure medium volume determined and, if appropriate, a leak is identified by the control unit 20 by setting a leakage flag if the difference exceeds a specified threshold. If, on the other hand, no leak is identified, it is assumed that the leak is located in the isolated brake circuit 1.1. This isolated state of the first brake circuit 1.1 is maintained until the cause of the leak is removed.

If, on the other hand, no leak is identified in this second brake circuit 1.2, the second brake circuit 1.2 is then isolated, and the first brake circuit 1.1 is checked for leaks during an ABS control operation in order to confirm that the leak must be in the first brake circuit 1.1. For this purpose, the second brake circuit 1.2 is controlled in such a way in synchronism with the ABS control of the first brake circuit 1.1 that the stability of the vehicle in terms of driving dynamics continues to be assured, e.g. by supplying the wheels 2.2 with a brake pressure which is just below that which would allow slip at these wheels 2.2.

The first brake circuit 1.1 is checked for leakage in the same way by detecting the associated brake pressure using the pressure sensor S and determining the pressure medium volume delivered during the ABS or ESC control operation by means of an algorithm stored in the control unit 20 on the basis of the sensor value of the rotor position sensor S4. The measured brake pressure is used to determine a model value for the pressure medium volume, which likewise indicates a theoretically correct value of the pressure medium volume required to build up the pressure value detected, and this model value is compared with the pressure medium volume determined and a leak is identified by the control unit 20 by setting a leakage flag if the difference exceeds a specified threshold. If this leak is located in the first brake circuit 1.1, the isolated state of this first brake circuit 1.1 is maintained until the cause of the leak is removed.

The most significant advantage of this leak location in an electrohydraulic brake system shown in FIG. 2 during an ongoing ABS control operation can be regarded as the fact that no additional sensors are required. The location of the leak can be achieved in all operating situations of the brake system using the existing sensors S to detect the pressure generated by the pressure source 3 and the pressure medium volume delivered by the pressure source 3.

List of reference signs

| | |
|---|---|
| 1 | Brake system |
| 1.1 | First brake circuit of the brake system 1 |
| 1.2 | Second brake circuit of the brake system 1 |
| 2.1 | Left-hand front wheel FL, right-hand rear wheel RR |
| 2.11 | Wheel brake of the first brake circuit 1.1 |
| 2.2 | Right-hand front wheel FR, left-hand rear wheel RL |
| 2.21 | Wheel brake of the second brake circuit 1.2 |
| 3 | Pressure source, electrohydraulic actuator |
| 3.1 | Pressure source, hydraulic pump of the first brake circuit 1.1 |
| 3.2 | Pressure source, hydraulic pump of the second brake circuit 1.2 |
| 4 | Electric drive motor, electric motor |
| 5 | Master brake cylinder |
| 5.1 | Brake booster |
| 5.2 | Reservoir for pressure medium |
| 6 | Brake pedal |
| 7.1 | Block valve of the first brake circuit 1.1 |
| 7.2 | Block valve of the second brake circuit 1.2 |
| 8.10 | Inlet valve of the first brake circuit 1.1 |
| 8.11 | Inlet valve of the first brake circuit 1.1 |
| 8.20 | Inlet valve of the second brake circuit 1.2 |
| 8.21 | Inlet valve of the second brake circuit 1.2 |
| 9.10 | Outlet valve of the first brake circuit 1.1 |
| 9.11 | Outlet valve of the first brake circuit 1.1 |
| 9.20 | Outlet valve of the second brake circuit 1.2 |
| 9.21 | Outlet valve of the second brake circuit 1.2 |
| 10.1 | Changeover valve of the first brake circuit 1.1 |
| 10.2 | Changeover valve of the second brake circuit 1.2 |
| 11.1 | Low-pressure reservoir of the first brake circuit 1.1 |
| 11.2 | Low-pressure reservoir of the second brake circuit 1.2 |
| 12.1 | Circuit block valve of the first brake circuit 1.1 |
| 12.2 | Circuit block valve of the second brake circuit 1.2 |
| 13 | Displacement simulator |
| S | Pressure sensor |
| S1 | Pressure sensor |
| S2 | Pressure sensor |
| S3 | Speed sensor |
| S4 | Rotor position sensor |
| S5 | Temperature sensor |
| S6 | Speed sensor |
| S7 | Pressure sensor |
| S8 | Displacement sensor |

1. A method for detecting a leak of a hydraulic brake system of a vehicle having a first brake circuit and a second brake circuit, the method comprising:
measuring brake pressure generated in the first and second brake circuits using corresponding pressure sensors during an ABS or ESC control operation;
determining a pressure medium volume delivered for the measured brake pressure by a speed sensor;
depending on the measured brake pressure, determining a model for the pressure medium volume delivered at the measure brake pressure by a control unit;
determining that a leak in the brake system exists if a difference between the pressure medium volume determined using the speed sensor and the pressure medium value exceeds a specified threshold.

2. The method as claimed in claim 1, wherein:
two wheel brakes respectively form the first and second brake circuits;
wherein wheel brakes of the first and second brake circuits are each connected to an electrically controllable pressure source wherein the controllable pressure sources of the two brake circuits are hydraulic pumps driven by a common electric drive motor;
wherein the pressure medium volume delivered by a hydraulic pump of each brake circuit is determined from a number of revolutions performed by the electric drive motor; and
a respective pressure sensor is provided in order to detect the brake pressure generated in the brake circuits on the basis of the pressure medium volume delivered.

3. The method of claim 2, wherein two wheel brakes respectively form a first and a second brake circuit, the two brake circuits are each connected to an electrically controllable pressure source via a circuit block valve, wherein the pressure source is designed as an electrohydraulic actuator, which is driven by an electric drive motor, and to detect the pressure medium volume delivered by the electrohydraulic actuator, the rotor position of the electric drive motor is detected by means of a rotor position sensor, to locate a leak, method steps are carried out by means of at least one of the two brake circuits, while the pressure modulation units of the other brake circuit are controlled in such a way that the associated wheel brakes generate a specified brake pressure, and
if no leak is indicated, method steps are carried out by means of the other brake circuit, while the pressure modulation units of the first brake circuit are controlled in such a way that the associated wheel brakes generate a specified brake pressure.

4. The method of claim 3, wherein, to locate a leak, the circuit block valves are controlled in such a way as to adopt the through flow position.
